(19) United States
(12) Patent Application Publication
(10) Pub. No.: US 2023/0399029 A1
(43) Pub. Date: Dec. 14, 2023

(54) OPERATOR BRAKE DETECTION FOR AUTONOMOUS VEHICLES

(71) Applicant: Baidu USA LLC, Sunnyvale, CA (US)

(72) Inventors: BAOPING YUAN, Sunnyvale, CA (US); TIANJIA SUN, Sunnyvale, CA (US); YAOMING SHEN, Sunnyvale, CA (US)

(21) Appl. No.: 17/809,995

(22) Filed: Jun. 30, 2022

Related U.S. Application Data
(60) Provisional application No. 63/350,778, filed on Jun. 9, 2022.

(51) Int. Cl. B60W 60/00; B60W 50/10; B60T 8/32

(52) U.S. Cl. CPC B60W 60/0053; B60W 50/10; B60T 8/3265; B60W 2050/0008

(57) ABSTRACT

In an embodiment, a brake control system determines a brake pedal travel value and a brake actuation position based on a brake pedal travel sensor and a motor actuation sensor of an autonomous driving vehicle (ADV). The brake control system determines a first threshold value based on the brake actuation position. The brake control system determines a deviation of the observed brake pedal travel value from the brake actuation position or the raw brake pedal sensor value are above the first threshold value and detects an intention of an operator to apply a brake control in response to determining that the deviation is above the first threshold value. This way, brake intervention can be detected prior to steady state and detection of an operator intervention is robust and reliable.

### RELATED APPLICATIONS

This application claims the priority of U.S. provisional patent application No. 63/350,778, filed Jun. 9, 2022, which is incorporated by reference in its entirety.

### TECHNICAL FIELD

Embodiments of the present disclosure relate generally to operating autonomous driving vehicles. More particularly, embodiments of the disclosure relate to operator brake detection for autonomous vehicles.

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Brake control is a critical operation in autonomous driving. Pressure requests from the autonomous driving system (ADS) should be canceled immediately if an operator has engaged the brakes during autonomous driving (AD) events. However, since deceleration requests from AD and driver requests often use the same sensors input, a highly robust and sensitive driver brake intervention detection mechanism for AD is critical.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating an example of a brake intention module according to one embodiment.

FIG. 5 is a block diagram illustrating an example of a hydraulic brake system according to one embodiment.

FIG. 6A is a block diagram illustrating an example of a brake control system according to one embodiment.

FIG. 6B is a block diagram illustrating an example of a brake pedal observer module according to one embodiment.

FIG. 7 is a block diagram illustrating an example to detect brake intention in a steady state according to one embodiment.

FIG. 8 is a block diagram illustrating an example to detect brake intention during a deceleration request according to one embodiment.

FIG. 9 is a block diagram illustrating an example to detect brake intention during a brake hold according to one embodiment.

FIG. 10 is a block diagram illustrating an example to detect brake intention during a brake release according to one embodiment.

FIG. 11 is a block diagram illustrating an example to detect brake intention during a deceleration request with two or more reputable brake pushes according to one embodiment.

FIG. 12 is a block diagram illustrating an example to detect brake intention during a ramped deceleration request according to one embodiment.

FIG. 13A is a block diagram illustrating a brake actuation mapping table according to one embodiment. FIG. 13B is a chart illustrating the brake actuation mapping table of FIG. 13A.

FIG. 14 is a flow diagram illustrating a method to detect operator brake intention according to one embodiment.

FIG. 15 is a flow diagram illustrating a method to detect operator brake intention according to another embodiment.

### DETAILED DESCRIPTION

Various embodiments and aspects of the disclosures will be described with reference to the details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a brake control system detects brake intervention of an operator from measurements of a pedal travel value and measurements of a brake motor actuation position of a brake booster. If it is determined an operator intervened/engaged the brakes, the brake control system signals to the autonomous driving system (ADS) to cancel the autonomous driving (AD) events and returns operations of the ADV to an operator so the operator can manually control the ADV.

The brake controls can be measured by a pedal travel distance sensor of a brake booster of the brake system. When different types of brake AD events (hard deceleration, brake hold, brake release, a ramped deceleration, etc.) are requested by the ADS, the measured pedal travel distance sensor value can reflect both the manual intervention of an operator and the AD events, since the pedal travel sensor value reflects the brake controls operated by both the ADS and the operator.

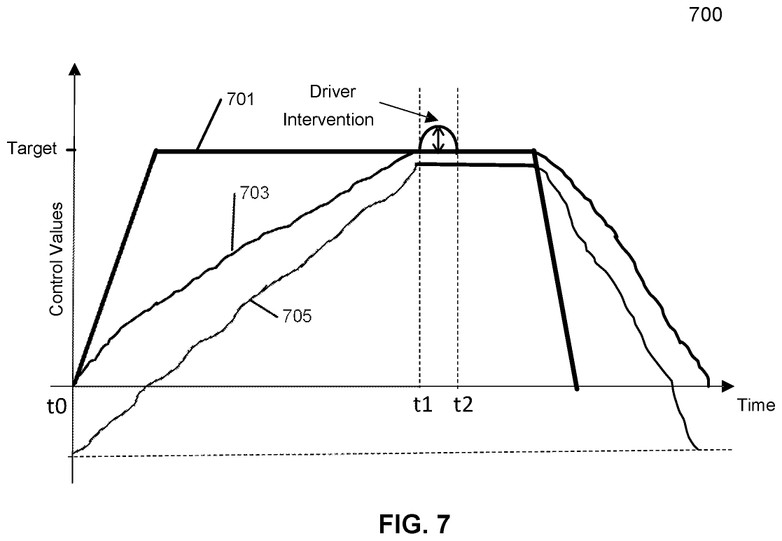

Currently, when an operator intervenes, the measurement value is insensitive to the degree of pedal travel (requires an operator to register a large pedal travel distance) and is slow (more than one planning cycles). An example of such an operator intention detection is shown in FIG. 7. As shown in FIG. 7, signal 701 can be a pedal travel distance requested by one or more AD events of the ADS, signal 703 can be the measured pedal travel distance value from a pedal travel sensor, and signal 705 can be a measured actuation position of an electric motor that is boosting/actuating the brake. When the ADS requests a deceleration (e.g., signal 701 is requested to be at Target value), observed signal 703 can be measured at each planning cycle to detect if the observed signal 703 is above the requested Target value. If it is determined signal 703 is above the Target value, it is detected that an operator intervened the brake control. Note that the brake booster boosts the performance of the brakes. A brake booster makes it easier for the driver to brake by increasing the force exerted without the need for additional force applied on the foot pedal.

As described above, using the current detection methodology, detecting the operator intervention reliably can be slow because the brake control system has to wait for the brake controls to settle to a steady state, e.g., at time=t1 to t2, for the ADS brake controls to be reliably discerned from operator intervention. Furthermore, the detection of operator intention is insensitive for a time window between time=t0 and t1, since the operator intervention may or may not register if the operator pressed the brake pedal, e.g., only if the operator pressed the brake pedal enough to register a large pedal travel distance (>Target value) then the operator intervention can be detected. Thus, there is a need to isolate a brake control detection of the operator from that of the ADS for a robust operator intervention detection.

According to a first aspect, a brake control system determines and observers a brake pedal travel value and a brake actuation position based on a brake pedal travel sensor and a motor actuation sensor of an autonomous driving vehicle (ADV). The brake control system determines a first threshold value based on the brake actuation position. The brake control system determines a deviation of the observed brake pedal travel value from the brake actuation position is above the first threshold value and detects an intention of an operator to apply a brake control in response to determining that the deviation is above the first threshold value. In one embodiment or in an alternative, the brake control system determines a deviation of the observed brake pedal travel value from the raw pedal travel sensor value is above a threshold value and detects an intention of an operator to apply a brake control in response to determining that the deviation is above this threshold value. This way, brake intervention also can be detected robustly and reliably.

According to a second aspect, a brake control system determines a first and a second brake pedal travel values of an autonomous driving vehicle (ADV) corresponding to a first and a second planning cycles respectively. The brake control system determines a difference value between the first and second brake pedal travel values. The brake control system detects an intention of an operator to apply a brake control in response to determining that the difference value between the first and second brake pedal travel values is above a predetermined threshold. In this scenario, the brake intervention can be detected robustly and reliably.

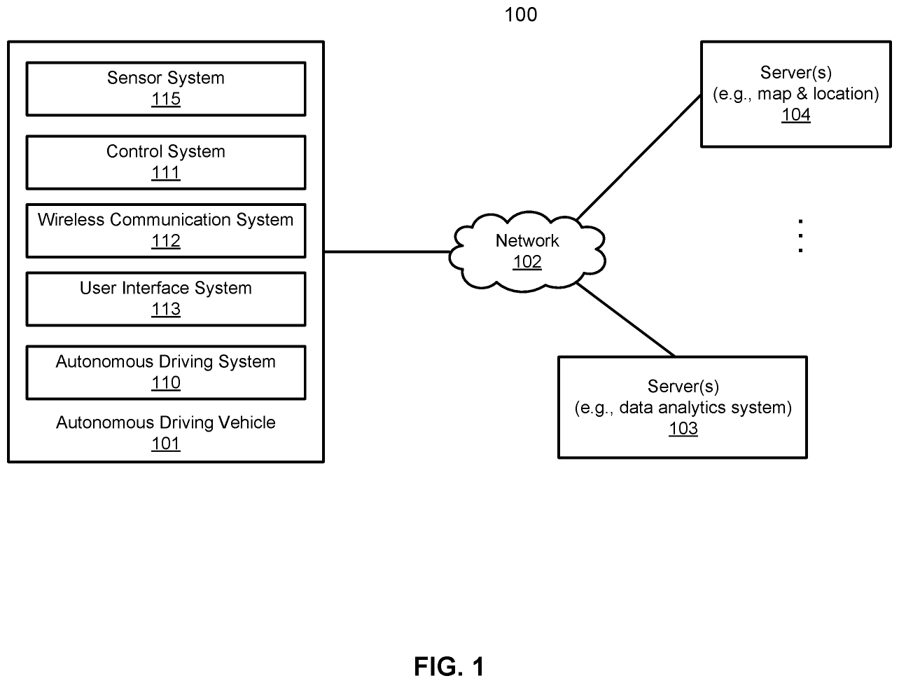

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

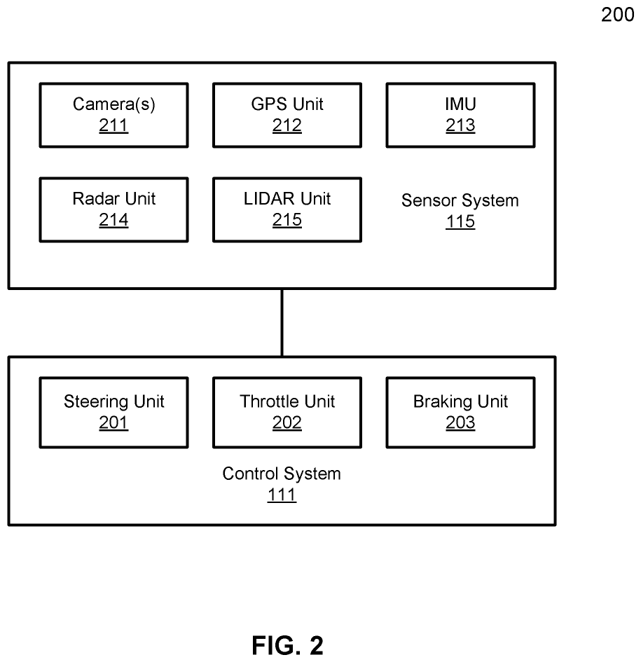

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

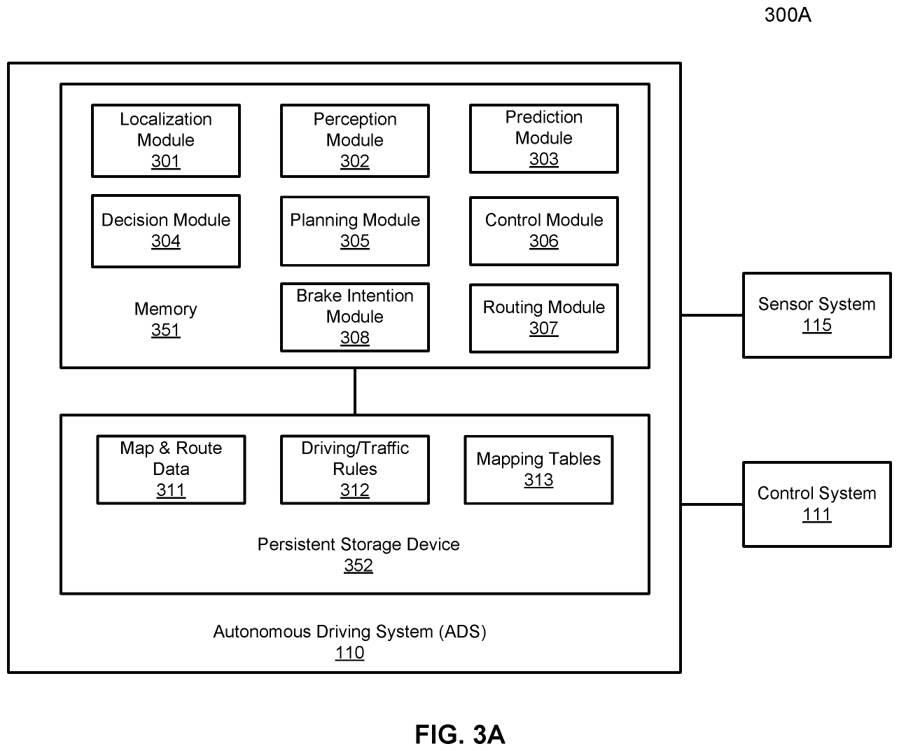

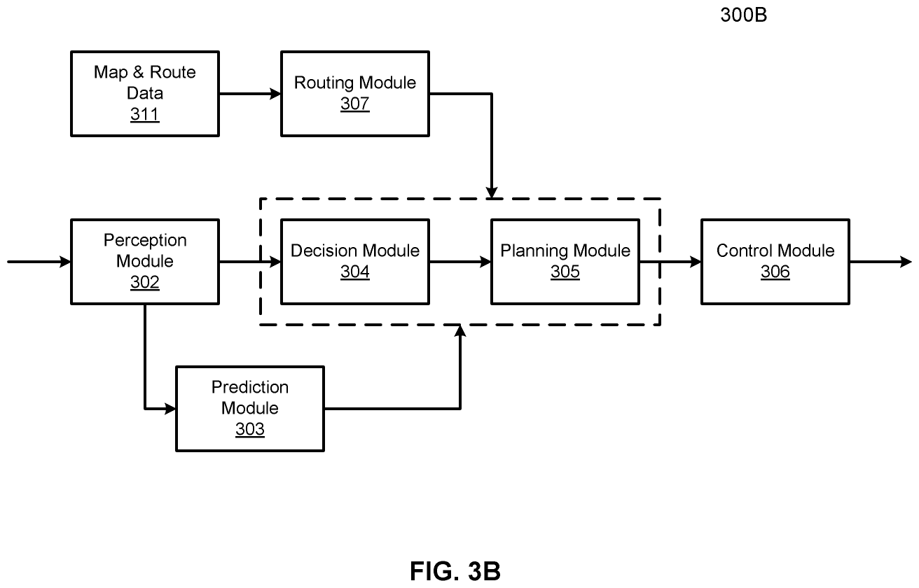

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, routing module 307, and brake intention module.

Some or all of modules 301-308 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-308 may be integrated together as an integrated module.

Localization module 301 determines a current location of ADV 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 300, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

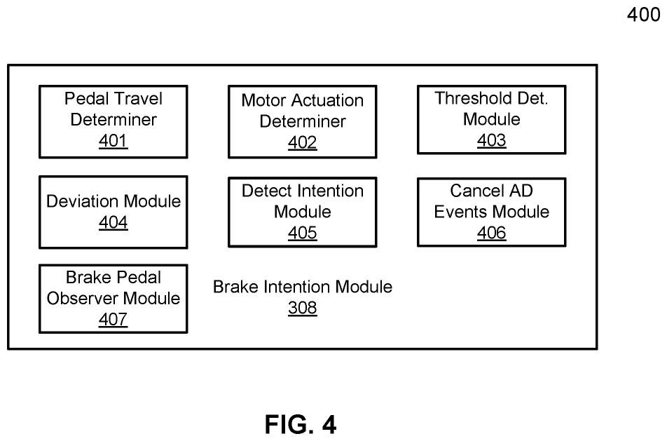

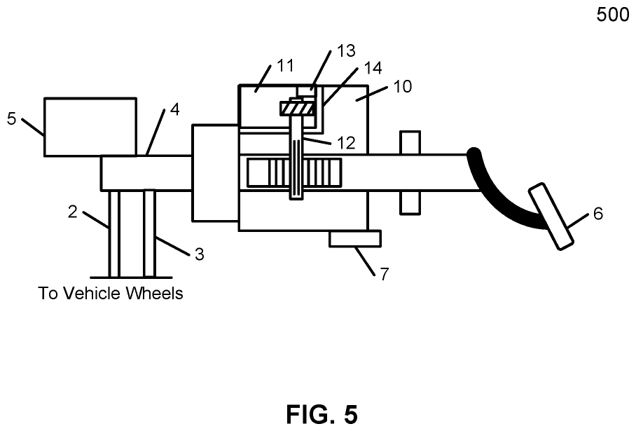

FIG. 4 is a block diagram illustrating an example of a brake intention module 308 according to one embodiment. Brake intention module 308 can detect an operator intention to apply a brake control. In one embodiment, brake intention module 308 can include pedal travel determiner module 401, motor actuation determiner module 402, threshold determiner module 403, deviation module 404, detect intention module 405, cancel AD events module 406, and brake pedal observer module 407. Pedal travel determiner module 401 can determine and observe a pedal travel distance sensor value by obtaining a measurement reading from a brake pedal travel sensor of a brake booster. Motor actuation determiner module 402 can determine a motor actuation position of a motor in the brake booster that electronically controls the brake pedal travel distance from a motor actuation sensor. Threshold determiner module 403 can use the measured motor actuation position to obtain a mapping value from a mapping table, such as mapping tables 313 of FIG. 3A, and calculate a threshold value. The threshold value can correspond to a threshold value that the pedal travel distance sensor value needs to exceed to register an operator intervention or a threshold value that a difference of the pedal travel distance sensor value and actuation position need to exceed to register an operator intervention. Deviation module 404 can determine a deviation value for any of the brake pedal travel sensor, actuation position, and threshold. Detect intention module 405 can detect an operator intervention using the deviation value. Cancel AD events module 406 can cancel the AD events that are issued or pending issuance to the ADV. Here, the AD events can include acceleration request, driving steering request, a signal request, a deceleration request, etc. Brake pedal observer module 407 can determine an observed brake pedal travel value. The operations of modules 401-407 are further described with respect to FIGS. 5-14.

FIG. 5 shows a representation of a hydraulic brake system 500 for a vehicle. Vehicle brake system 500 can include a front axle brake circuit 2 and a rear axle brake circuit 3 for actuating wheel brake devices (not shown) for the wheels of the ADV using a brake fluid that is under hydraulic pressure. Brake circuits 2, 3 can be connected to master brake cylinder 4 that is supplied with the brake fluid by a brake fluid reservoir container 5. A master brake cylinder piston within master brake cylinder 4 is operable via brake pedal 6.

In one embodiment, brake system 500 includes a braking force booster 10 that is coupled between brake pedal 6 and master brake cylinder 4. Booster 10 can include an electric motor 11, mechanical gearbox 12, and an electronic control unit (ECU) 14. ECU 14 can present a microcontroller that controls the actuations of booster 10. Booster 10 can boost a brake control that is applied by an operator. For example, a brake pedal travel distance that is exerted by an operator can be measured by pedal travel sensor 7. A signal of pedal travel sensor 7 can be transmitted to ECU 14 of booster 10 to cause gears of mechanical gearbox 12 to rotate thereby boosting the applied brake pedal and causing the hydraulic brake pressure at master brake cylinder 4 to increase. In one embodiment, the actuation position of electric motor 11 can be measured by an actuation sensor 13.

Brake fluid can be carried in each brake circuit 2, 3 and are supplied to brake devices (not shown) of the vehicle wheels. The brake hydraulics can further include a hydraulic pump (not shown) to control the hydraulic brake pressure of the brake hydraulics.

For an autonomous driving mode, an ADS can request brake controls (e.g., a pedal travel distance) by sending a signal to ECU 14 of booster 10 to cause gears of the mechanical gearbox 12 to rotate and to actuate the piston of the master brake cylinder 4. Furthermore, a brake control system can obtain sensors values from ECU 14 of booster 10 to obtain measurements of travel sensor 7 and/or actuation sensor 13.

Although the vehicle brake hydraulics system is described with brake fluid hydraulics, the embodiments are not limited to fluid hydraulic brakes. For example, an electronic brake system can be used instead of the fluid hydraulics brake system.

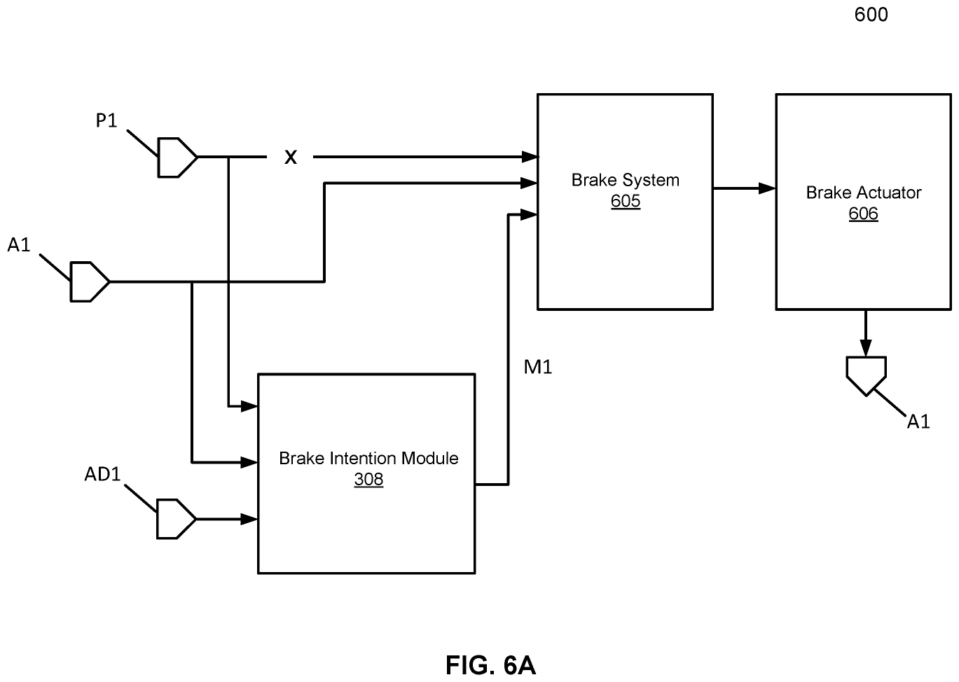

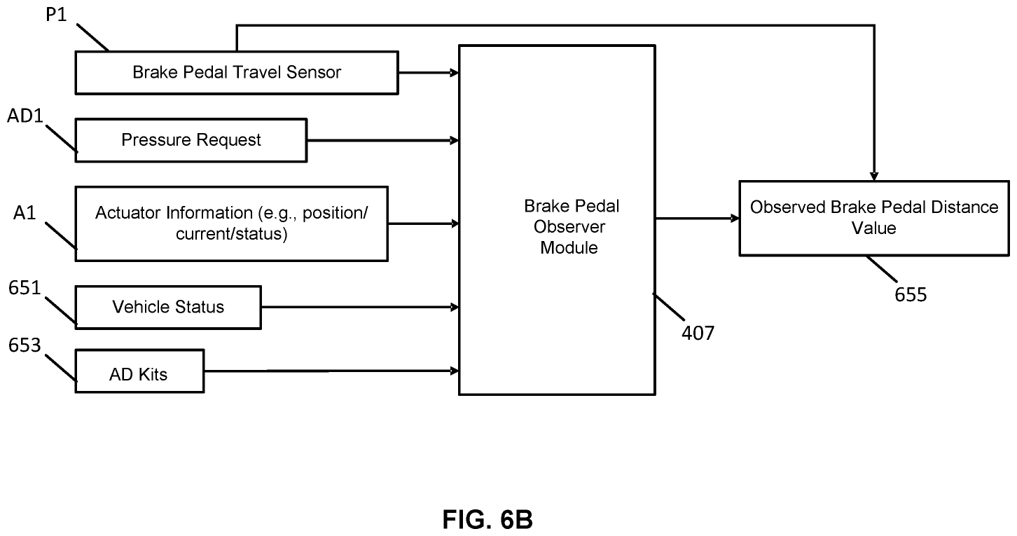

FIG. 6A is a block diagram illustrating an example of a brake control system 600 according to one embodiment. Brake control system 600 can be a modified brake system (e.g., signal P1 is routed to brake intention module 308) that actuates the brakes according to either AD events or brake pedal sensor signal from P1. For example, when an operator intervention is detected, brake control system 600 can cancel AD events and clear an event queue buffer for the ADS and actuate the brakes according to manual brake operations of the operator that would be detected at P1. When an operator intervention is not detected, brake control system 600 can actuate the brakes according to AD events.

In one embodiment, brake control system 600 can include brake intention module 308, brake system 605 and brake actuator 606. Brake intention module 308 can receive brake pedal sensor value P1, brake actuator position sensor value A1, and ADS signals AD1, and determine signal M1 that is issued to brake system 605. M1 can represent P1 when brake intention module 308 detects operator intervention or M1 can represent AD1 when brake intention module 308 discerned non-intervened autonomous driving operations. The actuation sensor that measure the actuation position value Al can be associated with brake actuator 606, e.g., the actuation position sensor is in a feedback loop with the autonomous driving system (ADS) of the ADV.

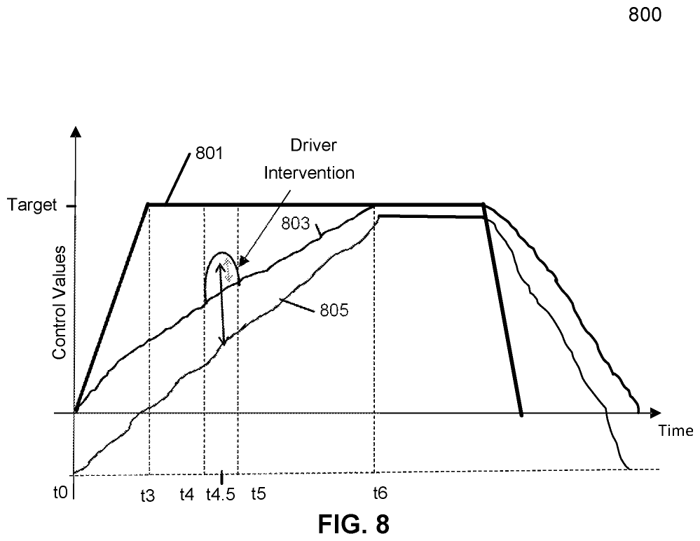

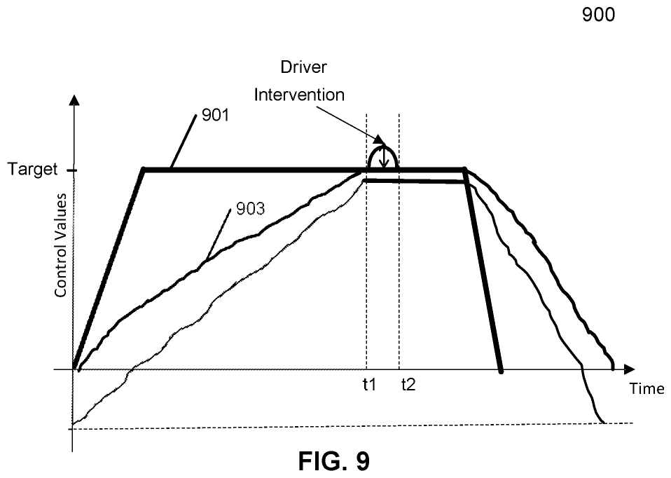

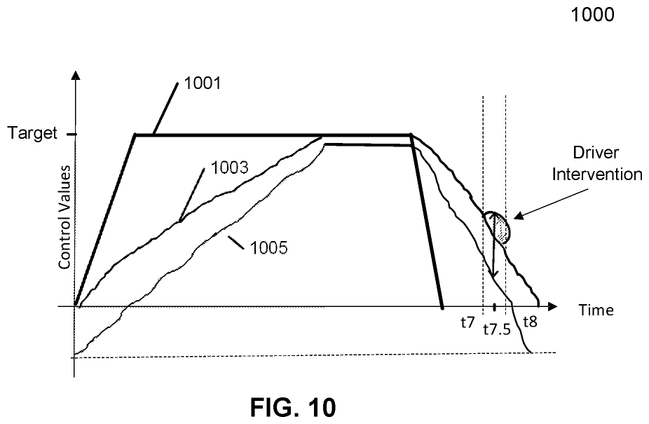

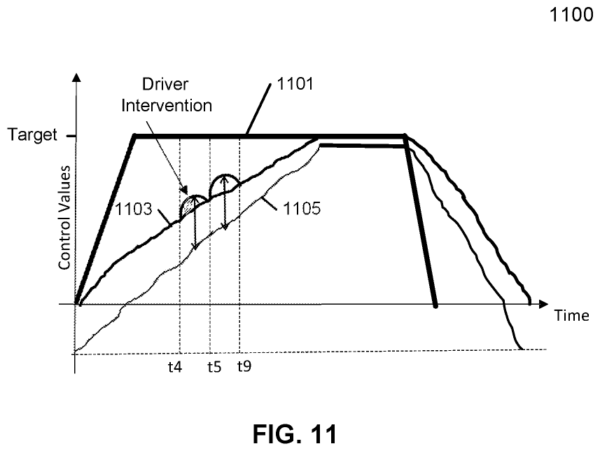

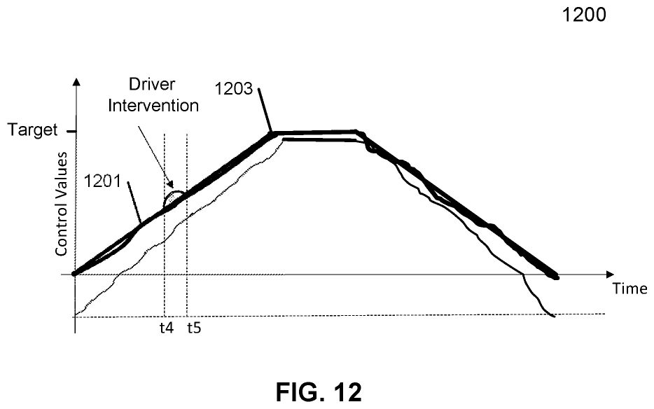

FIG. 6B is a block diagram illustrating an example of a brake pedal observer module 407 according to one embodiment. As shown, brake pedal observer module 407 can receive inputs from pedal travel sensor P1, pressure request AD1, actuator information Al (e.g., position of the actuator, power that is applied of the actuator, a status of the actuator (on, off, etc.), vehicle status 651 (e.g., accelerating, decelerating, etc.), and AD kits 653 (Using a combination of the inputs, brake pedal observer module 407 can determine an observed brake pedal distance value 655. The observed brake pedal distance value 655 can correspond to 803 of FIG. 8, 903 of FIG. 9, 1003 of FIG. 10, 1103 of FIGS. 11, and 1203 of FIG. 12.

In some embodiments, brake control system 600 can be implemented in software, hardware, or a combination thereof. For example, software portions of brake control system 600 can be installed in persistent storage device 352, loaded into memory 351, and executed by one or more processors (not shown). Note that brake control system 600 can be communicatively coupled to or integrated with some or all modules of vehicle control system 111 of FIG. 2 and/or modules 301-308 of FIG. 3A.

FIG. 8 is a block diagram illustrating an example 800 to detect brake intervention during a deceleration request according to one embodiment. The operation brake intention/intervention detection can be performed by operator intention module 308 of FIG. 4 or brake control system of FIG. 6A. As shown in FIG. 8, when an ADS requests a brake operation, an AD event of deceleration is requested by the ADS and the AD event can be received by module 308. The requested pedal travel control 801 of the AD event can be represented by an up ramp curve, where the request is for a target control value Target by time t3. As shown, brake system reaches a steady state at time=t6 when the requested pedal travel distance value 801 is equal to the observed pedal travel distance value 803. The actuation position 805 can be shown to lag behind the observed pedal travel distance value 803.

In this scenario, an operator intervenes the brake controls by pressing the brake pedal between time t4 and t5. In one embodiment, the brake control system detects the operator intervention by determining that the observed brake pedal travel sensor value 803 suddenly has a large change (delta) for a predetermined time period. For example, t4 can correspond to planning cycle 1 and t5 can corresponding to planning cycle 2. When the delta value of the pedal travel distance measured is greater than a predetermined threshold for the time between planning cycle 1 and planning cycle 2, the control system can detect that an operator has intervened, e.g., engaged the brake pedal. Planning cycles 1-2 can correspond to two consecutive planning cycles (a planning cycle can be 10 ms or larger) or any two non-consecutive planning cycles. In one embodiment, the brake control system determines that a deviation of the observed brake pedal travel value from the raw pedal travel sensor value is above a predetermined threshold value (e.g. 0.1) and detects an intention of an operator to apply a brake control in response to determining that the deviation is above this predetermined threshold value.

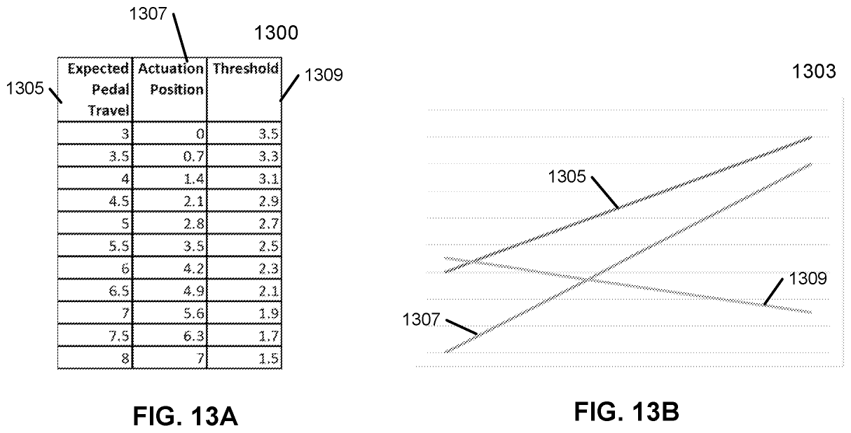

In another embodiment, the brake control system detects the operator intervention by determining that the observed brake pedal travel sensor value 803 minus the motor actuator value 805 is greater than a threshold for a determined time period. For example, at time=t4.5 (e.g., a planning cycle), the system can determine that the brake pedal travel sensor value is 7 and the motor actuator value is 2.8. Using the motor actuator value of 2.8, the system can determine a threshold value equals to 2.7. The threshold value can be determined using a mapping table, such as mapping table 1300 of FIG. 13A. Using the determined threshold, system can determine that the observed brake pedal travel sensor value minus the motor actuator value is greater than the threshold, e.g., 7−2.8>2.7. Thus, the system detects that an operator has intervened. In this case, the operator intervention/intention can be robustly detected during the time period when the control signals ramp up, e.g., from time t0 to t6.

Referring to FIG. 13A, mapping table 1300 can refer to historical data values that are collected by an ADV, e.g., ADV 101, without any operator interventions. Mapping table 1300 can correspond to a particular targeted pedal travel distance stored in as mapping tables 313 of FIG. 3A. The historical data values can include pedal travel distance values 1305 and actuation position values 1307. The threshold value 1309 can be calculated as: pedal travel distance 1305−actuation position value 1307+a predetermined value (e.g., 0.5). In another embodiment, the threshold value can be calculated using a formula, where the pedal travel distance and the actuation position value are represented as a linear curve of y=a*x+b or a quadratic curve y=a*x\hat{ }2+b*x+c, or other curves. FIG. 13B illustrates the pedal travel distance values 1305, actuation position values 1307, and threshold value 1309 in chart curves.

FIG. 9 is a block diagram illustrating an example 900 to detect brake intention during a brake hold according to one embodiment. Example 900 can correspond to example 800 of FIG. 8. As shown in FIG. 9, at time t1 to t2, ADS requests for a brake hold and the brake hold is reflected by the requested brake pedal travel value 901 being approximately the same as the sensor observer for the observed pedal travel value 903. In one embodiment, during the brake hold, the brake control system can detect an operator intervention by determining that the observed brake pedal travel sensor value 903 has suddenly changed by a predetermined amount within a predetermined time period. For example, t1 can correspond to planning cycle 1 and t2 can corresponding to planning cycle 2. When a change of the observed pedal travel distance 903 is greater than a predetermined threshold (e.g., 0.5) for the time between the planning cycle 1 and planning cycle 2, the control system can detect that the operator has intervened, e.g., pressed the brake pedal. Planning cycles 1-2 can correspond to two consecutive planning cycles (each planning cycle can be 100 ms) or any two non-consecutive planning cycles.

In another embodiment, the brake control system detects the operator intervention by determining that the observed brake pedal travel sensor value 903 is greater than the requested brake pedal travel value 901 minus a predetermined threshold (e.g., 0.5) for a certain predetermined period (e.g., 0.02 s). For example, at time=t1, the system can determine the requested brake pedal travel sensor value 901 to be the Target value and the observed brake pedal travel sensor value 903 to be approximately the Target value. Thus, Target>Target−0.5 and the system determines that the operator intervened.

FIG. 10 is a block diagram illustrating an example 1000 to detect brake intention during a brake release according to one embodiment. Example 1000 can correspond to example 800 of FIG. 8. As shown in FIG. 10, for a break release AD event, ADS requests for the brake control to be released. The characteristics of the requested control signal 1001 is representative of a down ramp curve and the observed pedal travel sensor value 1003 and measured actuation position sensor value 1005 follow the down ramp curve of 1001.

In one embodiment, the brake control system detects the operator intervention by determining that the observed brake pedal travel sensor value 1003 suddenly has a large change (delta) for a predetermined time period. For example, t7 can correspond to planning cycle 1 and t8 can corresponding to planning cycle 2. When the delta value of the pedal travel distance measured is greater than a predetermined threshold (e.g., 0.5) for the time between planning cycle 1 and planning cycle 2, the control system can detect that an operator has intervened, e.g., pressed the brake pedal. Planning cycles 1-2 can correspond to two consecutive planning cycles (each planning cycle can be 100 ms) or any two non-consecutive planning cycles.

In another embodiment, the brake control system detects the operator intervention by determining that the observed brake pedal travel sensor value 1003 minus the motor actuator value 1005 is greater than a threshold. For example, at time=t7.5 (a planning cycle), the system can determine that the brake pedal travel sensor value to be 5 and the motor actuator value to be 2.4. Using the motor actuator value of 2.4, the system can extrapolate and determine a threshold value to be approximately 2.8. The threshold value can be determined using mapping table 1300 of FIG. 13A. Using the determined threshold, system can determine that the brake pedal travel sensor value minus the motor actuator value is greater than a threshold, e.g., 5−2.4>2.8. Thus, the system detects that an operator has intervened.

FIG. 11 is a block diagram illustrating an example 1100 to detect brake intention during a deceleration request with two or more brake control presses according to one embodiment. Example 1100 can represent example 800 of FIG. 8. As shown in FIG. 11, ADS requested for deceleration at time=t0 and the requested pedal travel value 1101 is representative of an up ramp curve. The observed pedal travel value 1103 correspondingly ramps up following the requested pedal travel value 1101. During the ramp up, an operator presses the brake control consecutively twice or more, indicative of an intention to take over manual operation of the vehicle. In this scenario, the brake control system can detect operator intervention as follows.

In one embodiment, the brake control system detects the operator intervention by determining that the observed brake pedal travel sensor value 1103 suddenly has a large change (delta) for a predetermined time period, e.g., between t4 and t5, or t5 and t9. For example, t4 can correspond to planning cycle 1, t5 can corresponding to planning cycle 2, and t9 can correspond to planning cycle 3. When the delta value of the observed pedal travel distance is greater than a predetermined threshold for the time between planning cycle 1 and planning cycle 2 or between planning cycle 2 and planning cycle 3, the control system can detect that an operator has intervened, e.g., pressed the brake pedal. Planning cycles 1-3 can correspond to three consecutive planning cycles (a planning cycle can be 100 ms) or any three non-consecutive planning cycles. In one embodiment, the two brake control engagements can be detected as separate operator interventions.

FIG. 12 is a block diagram illustrating an example 1200 to detect brake intention during a ramped deceleration request according to one embodiment. Example 1200 can represent example 900 of FIG. 9. As shown in FIG. 12, ADS requests the pedal travel values as a ramp curve via signal 1201. Since the AD request represents a ramp curve, the observed pedal travel values 1203 correspondingly follows the requested curve 1201. In this scenario, operator intention can be detected similar to example 900.

For example, in one embodiment, the brake control system can detect the operator intervention by determining that the observed brake pedal travel sensor value 1203 has suddenly changed by a predetermined amount within a predetermined time period. For example, t4 may correspond to planning cycle 1 and t5 can corresponding to planning cycle 2. When a change of the observed pedal travel distance 1203 is greater than a predetermined threshold (e.g., 0.5) for the time between the planning cycle 1 and planning cycle 2, the brake control system can detect that the operator has intervened, e.g., pressed the brake pedal. Planning cycles 1-2 can correspond to two consecutive planning cycles (each planning cycle can be 100 ms) or any two non-consecutive planning cycles.

In another embodiment, the brake control system detects the operator intervention by determining that the observed brake pedal travel sensor value 1203 is greater than the requested brake pedal travel value 1201 minus a predetermined threshold (e.g., 0.5). For example, at time=t4, the system can determine that the requested brake pedal travel sensor value 1201 is equal to Target value and the observed brake pedal travel sensor value 1203 to be approximately the Target value. Thus, Target>Target−0.5 and the system determines that the operator intervened.

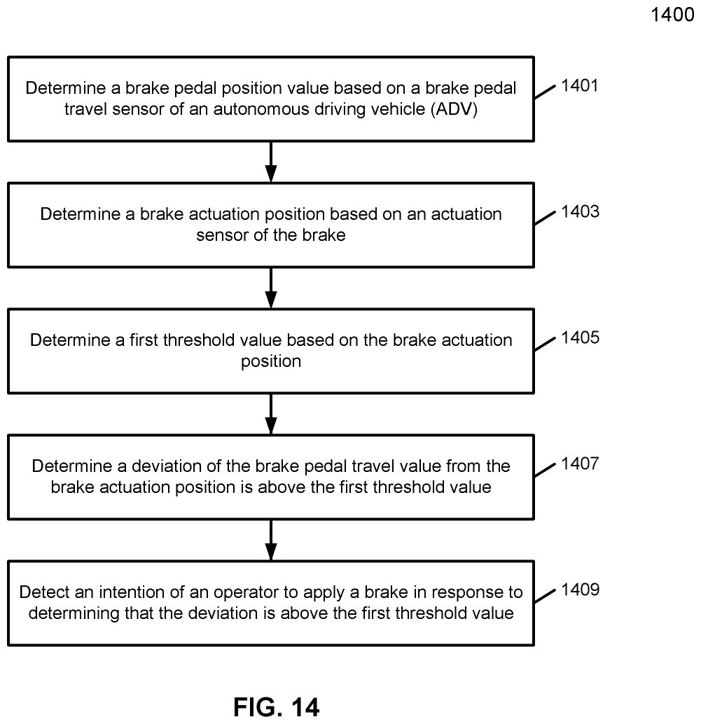

FIG. 14 is a flow diagram illustrating a method to detect operator brake intention according to one embodiment. Process 1400 may be performed by processing logic which may include software, hardware, or a combination thereof. For example, process 1400 may be performed by brake intention module 308 of FIG. 1.

At block 1401, processing logic determines a brake pedal travel value based on a brake pedal travel sensor of an autonomous driving vehicle (ADV). At block 1403, processing logic determines a brake actuation position based on an actuation sensor of the ADV.

At block 1405, processing logic determines a first threshold value (threshold 1309 of FIG. 13A) based on the brake actuation position. At block 1407, processing logic determines a deviation of the brake pedal travel value from the brake actuation position is above the first threshold value. At block 1409, processing logic detects an intention of an operator to apply a brake control in response to determining that the deviation is above the first threshold value. See example 800 of FIG. 8.

In one embodiment, in response to detecting the intention of an operator to apply a brake control, processing logic cancels autonomous driving events of an autonomous driving system of the ADV to return driving operations to an operator.

In one embodiment, the first threshold value is a dynamic threshold proportional to the brake actuation position of the ADV, where the dynamic threshold is determined based on a mapping table, such as mapping table 1300 of FIG. 13A.

In one embodiment, determining that the deviation of the brake pedal travel value from the brake actuation position is above the first threshold value is performed when an autonomous driving system of the ADV has requested the ADV to decelerate.

In one embodiment, processing logic determines a change in the brake pedal travel value between a first planning cycle and a second planning cycles is above a predetermined threshold. Processing logic detects the intention of an operator to apply a brake control in response to determining that the change in the brake pedal travel value is above the predetermined threshold. See example 800 of FIGS. 8 and/or 1000 of FIG. 10.

In one embodiment, processing logic determines a change in the brake pedal travel value between the second planning cycle and a third planning cycle is above the predetermined threshold. Processing logic detects the intention of an operator to apply a brake control in response to determining that the change in the brake pedal travel value is above the predetermined threshold (e.g. 0.3) between any of the first, second, or third planning cycles. See example 1100 of FIG. 11.

In one embodiment, processing logic determines the brake pedal travel value is above a brake pedal travel value requested by an autonomous driving system of the ADV. Processing logic detects detecting the intention of an operator to apply a brake control in response to determining that the brake pedal travel value is above the requested brake pedal travel value. See example 900 of FIG. 9 and/or example 1200 of FIG. 12.

In one embodiment, the actuation sensor is in a feedback loop for an autonomous driving system (ADS) of the ADV. In one embodiment, the actuation sensor includes a sensor (sensor 13 of FIG. 5) that captures a position of an actuation motor (motor 11) of a brake booster (booster 10). In one embodiment, processing logic measures a signal from the brake pedal travel sensor and measures a signal from the actuation sensor from an electronic control unit (ECU) of a brake booster to determine the intention of an operator to apply a brake control.

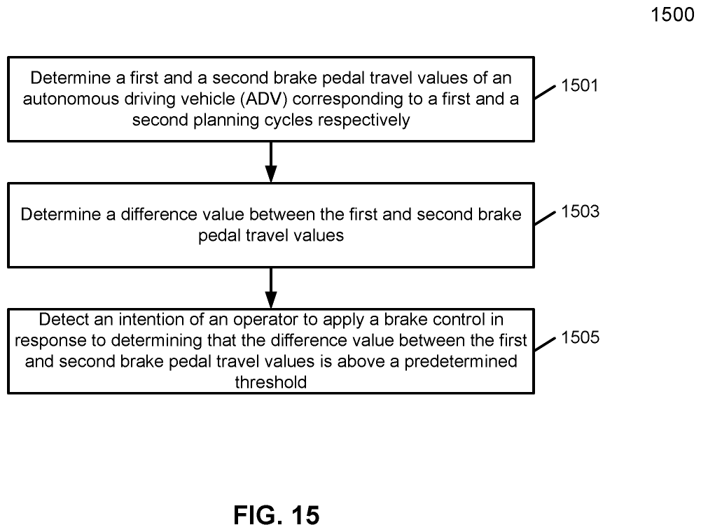

FIG. 15 is a flow diagram illustrating a method to detect operator brake intention according to another embodiment. Process 1500 may be performed by processing logic which may include software, hardware, or a combination thereof. For example, process 1500 may be performed by brake intention module 308 of FIG. 1.

At block 1501, processing logic determines a first and a second brake pedal travel values of an autonomous driving vehicle (ADV) corresponding to a first and a second planning cycles respectively.

At block 1503, processing logic determines a difference value between the first and second brake pedal travel values. At block 1505, processing logic detects an intention of an operator to apply a brake control in response to determining that the difference value between the first and second brake pedal travel values is above a predetermined threshold. See example 800 of FIG. 8.

In one embodiment, in response to detecting the intention of an operator to apply a brake control, processing logic further cancels autonomous driving events of an autonomous driving system of the ADV to return driving operations to an operator.

In one embodiment, processing logic determines a brake actuation position based on an actuation sensor of the ADV. Processing logic determines a deviation of the first brake pedal travel value from the brake actuation position is above a first threshold value. Processing logic detects an intention of an operator to apply a brake control in response to determining that the deviation is above the first threshold value. See example 800 of FIG. 8.

In one embodiment, the first threshold value is a dynamic threshold proportional to the brake actuation position of the ADV, wherein the dynamic threshold is determined based on a mapping table.

In one embodiment, determining the delta between the first and second brake pedal travel values is performed when an autonomous driving system of the ADV has requested the ADV to decelerate. See example 800 of FIG. 8.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method, comprising:
determining a brake pedal travel value based on a brake pedal travel sensor of an autonomous driving vehicle (ADV);
determining a brake actuation position based on an actuation sensor of the ADV;
determining a first threshold value based on the brake actuation position;
determining a deviation of the brake pedal travel value from the brake actuation position is above the first threshold value; and
detecting an intention of an operator to apply a brake control in response to determining that the deviation is above the first threshold value.

2. The method of claim 1, further comprising in response to detecting the intention of an operator to apply a brake control, cancelling autonomous driving events of an autonomous driving system of the ADV to return driving operations to an operator.

3. The method of claim 1, wherein the first threshold value is a dynamic threshold proportional to the brake actuation position of the ADV, wherein the dynamic threshold is determined based on a mapping table.

4. The method of claim 1, wherein determining that the deviation of the brake pedal travel value from the brake actuation position is above the first threshold value is performed when an autonomous driving system of the ADV has requested the ADV to decelerate.

5. The method of claim 1, further comprising:
determining a change in the brake pedal travel value between a first planning cycle and a second planning cycles is above a predetermined threshold; and
detecting the intention of an operator to apply a brake control in response to determining that the change in the brake pedal travel value is above the predetermined threshold.

6. The method of claim 5, further comprising:
determining a change in the brake pedal travel value between the second planning cycle and a third planning cycle is above the predetermined threshold; and
detecting the intention of an operator to apply a brake control in response to determining that the change in the brake pedal travel value is above the predetermined threshold between any of the first, second, or third planning cycles.

7. The method of claim 1, further comprising:
determining the brake pedal travel value is above a brake pedal travel value requested by an autonomous driving system of the ADV; and
detecting the intention of an operator to apply a brake control in response to determining that the brake pedal travel value is above the requested brake pedal travel value.

8. The method of claim 7, wherein the actuation sensor is in a feedback loop for an autonomous driving system (ADS) of the ADV.

9. The method of claim 1, wherein the actuation sensor includes a sensor that captures a position of an actuation motor of a brake booster.

10. The method of claim 1, further comprising measuring a signal from the brake pedal travel sensor and measuring a signal from the actuation sensor from an electronic control unit (ECU) of a brake booster to determine the intention of an operator to apply a brake control.

11. A non-transitory machine-readable medium having instructions stored therein, which when executed by a processor, cause the processor to perform operations, the operations comprising:
determining a brake pedal travel value based on a brake pedal travel sensor of an autonomous driving vehicle (ADV);
determining a brake actuation position based on an actuation sensor of the ADV;
determining that a deviation of the brake pedal travel value from the brake actuation position is above a first threshold value; and
detecting an intention of an operator to apply a brake control in response to determining that the deviation is above the first threshold value.

12. The non-transitory machine-readable medium of claim 11, wherein the operations further comprise in response to detecting the intention of an operator to apply a brake control, cancelling autonomous driving events of an autonomous driving system of the ADV to return driving operations to an operator.

13. The non-transitory machine-readable medium of claim 11, wherein the first threshold value is a dynamic threshold proportional to the brake actuation position of the ADV, wherein the dynamic threshold is determined based on a mapping table.

14. The non-transitory machine-readable medium of claim 11, wherein determining that the deviation of the brake pedal travel value from the brake actuation position is above the first threshold value is performed when an autonomous driving system of the ADV has requested the ADV to decelerate.

15. The non-transitory machine-readable medium of claim 11, wherein the operations further comprise:
determining a change in the brake pedal travel value between a first planning cycle and a second planning cycles is above a predetermined threshold; and
detecting the intention of an operator to apply a brake control in response to determining that the change in the brake pedal travel value is above the predetermined threshold.

16. A computer-implemented method, comprising:
determining a first and a second brake pedal travel values of an autonomous driving vehicle (ADV) corresponding to a first and a second planning cycles respectively;
determining a difference value between the first and second brake pedal travel values; and
detecting an intention of an operator to apply a brake control in response to determining that the difference value between the first and second brake pedal travel values is above a predetermined threshold.

17. The method of claim 16, further comprising in response to detecting the intention of an operator to apply a brake control, cancelling autonomous driving events of an autonomous driving system of the ADV to return driving operations to an operator.

18. The method of claim 16, further comprising:
determining a brake actuation position based on an actuation sensor of the ADV;
determining a deviation of the first brake pedal travel value from the brake actuation position is above a first threshold value; and
detecting an intention of an operator to apply a brake control in response to determining that the deviation is above the first threshold value.

19. The method of claim 18, wherein the first threshold value is a dynamic threshold proportional to the brake actuation position of the ADV, wherein the dynamic threshold is determined based on a mapping table.

20. The method of claim 16, wherein determining the difference value between the first and second brake pedal travel values is performed when an autonomous driving system of the ADV has requested the ADV to decelerate.
